(19) United States
(12) Patent Application Publication
(10) Pub. No.: US 2011/0204620 A1
(43) Pub. Date: Aug. 25, 2011

(54) APPARATUS, METHOD FOR CONNECTING PIPE AND METHOD FOR MANUFACTURING JAW OF HOLDER-JAW

(75) Inventors: Seung-Hyeon Kim, Seoul (KR); Yoon-Soo Seo, Gyeonggi-do (KR)

(73) Assignee: Join-Top Co., ltd, Incheon (KR)

(21) Appl. No.: 12/738,415

(22) PCT Filed: Oct. 17, 2008
(86) PCT No.: PCT/KR2008/006133

§ 371 Date: Apr. 16, 2010

(30) Foreign Application Priority Data
Oct. 18, 2007 (KR) 10-2007-0105091
Oct. 16, 2008 (KR) 10-2008-0101498

(51) Int. Cl. F16L 27/00; B23P 19/00

(52) U.S. Cl. 285/302; 29/525.01

(57) ABSTRACT

An apparatus and method for interconnecting pipes, and a method for manufacturing a jaw of a jaw holder An apparatus/method are provided. The pipe connecting apparatus includes a pipe connecting member installed at a location where two pipes are interconnected, one or more jaw holder that are fixedly inserted into respective opposite end portions of the pipe connecting member in a state where they are respectively interposed between the pipe connecting member and the pipe and between the pipe connecting member and the pipe and provided with a plurality of jaw mounting holes that are formed along an outer circumference and spaced apart from each other at predetermined intervals, one or more jaws that are pivotally inserted into the respective jaw mounting holes and press and fix the pipes inserted into the jaw holders by being depressed by an inner wall of the pipe connecting member, and one or more elastic members that are installed in the pipe connecting member to elastically support the jaws. When the jaw holder is inserted into the pipe connecting member, the hooking protrusion moves over the inclined surface, the stopper is inserted into the seating groove, and thus the jaw holder is coupled to the pipe connecting member.

### TECHNICAL FIELD

The present invention relates to an apparatus and method for interconnecting pipes, and a method for manufacturing a jaw of a jaw holder and, more particularly, to an apparatus for interconnecting pipes, a method for interconnecting the pipes using the apparatus, and a method for manufacturing a jaw tightly fixing the pipes.

### BACKGROUND ART

Generally, a pipe connecting apparatus is mainly used as a unit for maintaining fluid-tightness of pipes by connecting and fixing the pipes to a pipe line along which fluid flows. The pipe connecting apparatus may be formed in a variety of types such as a straight type, an elbow type, a T-shape type, a cross-shape type.

Such a pipe connecting apparatus should be designed to ensure the fluid-tightness and coupling property between the pipes and not to be easily damaged or separated even when predetermined vibration and impact are applied to the pipe connecting apparatus.

However, in the related pipe connecting apparatus, in order to enhance the fluid-tightness and coupling property, there is a need to weld a coupling portion between the pipes or use separate fasteners such as screws and a snap ring. Therefore, it is difficult to perform pipe connecting work and the number of assembling processes increases, thereby increasing the pipe connecting costs.

Further, it is very difficult and time-consuming to couple a jaw holder to a pipe connecting member during the pipe connecting process.

### DISCLOSURE OF INVENTION

### Technical Problem

The present invention has been made in an effort to address the above-described problems. An object of the present invention is to provide a pipe connecting apparatus and method that are designed to improve fluid-tightness and coupling property.

Another object of the present invention is to provide a method for manufacturing a jaw of a jaw holder, which can improve the productivity of the jaws.

### Technical Solution

To achieve the objects, the present invention provides a pipe connecting apparatus including: a pipe connecting member installed at a location where two pipes are inter-connected; one or more jaw holder that are fixedly inserted into respective opposite end portions of the pipe connecting member in a state where they are respectively interposed between the pipe connecting member and the pipe and between the pipe connecting member and the pipe and provided with a plurality of jaw mounting holes that are formed along an outer circumference and spaced apart from each other at pre-determined intervals; one or more jaws that are pivotally inserted into the respective jaw mounting holes and press and fix the pipes inserted into the jaw holders by being depressed by an inner wall of the pipe connecting member; and one or more elastic members that are installed in the pipe connecting member to elastically support the jaws.

A seating groove provided with a hooking protrusion is formed along an outer circumference of the jaw holder and a stopper having an inclined surface is formed on an inner circumference of the pipe connecting member in response to the seating groove; and when the jaw holder is inserted into the pipe connecting member, the hooking protrusion moves over the inclined surface, the stopper is inserted into the seating groove, and thus the jaw holder is coupled to the pipe connecting member.

The jaw holder may be provided with a plurality of cut-away portions extending in a longitudinal direction thereof and spaced apart from the adjacent jaw mounting holes 121 at equal distances.

A jaw hinge fixing protrusion may be formed on a first end wall defining each of the jaw mounting holes and a jaw pivot stopper is formed on a second end wall defining each of the jaw mounting holes; a first coupling groove corresponding to the jaw hinge fixing protrusion may be formed at a first end of the jaw and a second coupling groove corresponding to the jaw pivot stopper is formed on a second end of the jaw; and the jaw may be designed to pivot about the jaw hinge fixing protrusion and a pivot range of the jaw is restricted by the jaw pivot stopper.

An inclined surface may be formed on the first end of the jaw so that the jaw pivot stopper is inserted and fixed in the second coupling groove over the inclined surface.

A backup ring, spring supporting ring, and sealing ring may be inserted into the pipe connecting member; and opposite side ends of each of the backup ring, spring supporting ring, and sealing ring are cut away so that they can be inserted into the pipe connecting member.

A backup ring, spring supporting ring, and sealing ring may be inserted into the pipe connecting member; and an inlet of the pipe connecting member is designed such that a diameter thereof in a horizontal direction is less than a diameter thereof in a vertical direction so that the backup ring, spring supporting ring, and sealing ring can be inserted into the pipe connecting member.

The elastic member is a ring-shaped leaf spring having both sections one which is elevated above the other.

The elastic member may be a ring-shaped leaf spring having upper and lower portions having different diameters.

A pipe connecting method according to one embodiment includes inserting jaw holders into respective opposite end portions of a pipe connecting member; allowing hooking protrusions of the jaw holders to contact inclined surfaces of stoppers of the pipe connecting member; inserting the stoppers into seating grooves by depressing the jaw holders and thus elastically deforming the hooking protrusions of the jaw holders; and allowing the jaws to press and fix pipes inserted into the jaw holders by allowing springs mounted in the pipe connecting member to resiliently support the jaws of the jaw holders.

A pipe connecting apparatus according to another embodiment includes a pipe connecting member disposed between two pipes and interconnecting the two pipes; one or more jaw holders that are fixedly inserted into respective opposite end portions of the pipe connecting member in a state where they are respectively interposed between the pipe connecting member and the pipe and between the pipe connecting member and the pipe and provided with a plurality of jaw mounting holes that are formed along an outer circumference and spaced apart from each other at pre-determined intervals; one or more jaws that are pivotally inserted into the respective jaw mounting holes and press and fix the pipes inserted into the jaw holders by being depressed by an inner wall of the pipe connecting member; and one or more elastic members that are installed in the pipe connecting member to elastically support the jaws.

The jaw holder is provided at an outer circumference thereof with a plurality of elastic hooking pieces spaced apart from each other at predetermined intervals and each having an inclined surface and the pipe connecting member is provided at an inner circumference thereof with a hooking protrusion corresponding to the elastic hooking pieces; and, when the jaw holder is inserted into the pipe connecting member, the hooking protrusion 311 moves over the inclined surfaces and thus resiliently hooked on ends of the elastic hooking pieces, and the jaw holder is coupled to an end portion of the pipe connecting member.

The elastic hooking pieces may be formed by cutting an outer circumference of the jaw holder.

A preliminary assembling protrusion is formed on an inner circumference of the jaw mounting hole to fix a position of the jaw.

A backup ring, spring supporting ring, and sealing ring are inserted into the pipe connecting member; and opposite side ends of each of the backup ring, spring supporting ring, and sealing ring are cut away so that they can be inserted into the pipe connecting member.

A backup ring, spring supporting ring, and sealing ring are inserted into the pipe connecting member; and an inlet of the pipe connecting member is designed such that a diameter thereof in a horizontal direction is less than a diameter thereof in a vertical direction so that the backup ring, spring supporting ring, and sealing ring can be inserted into the pipe connecting member.

A pipe connecting method according to another embodiment includes inserting jaw holders into respective opposite end portions of a pipe connecting member; allowing elastic hooking pieces of the jaw holders to contact hooking protrusions of the pipe connecting member; and coupling the jaw holders to the pipe connecting member by allowing the hook protrusion of the pipe connecting member to be hooked on the ends of the elastic holing pieces of the jaw holders by elastically deforming the elastic hooking pieces of the jaw holders by pressing the jaw holders.

A method for manufacturing a jaw of a jaw holder according to one embodiment includes preparing a steel sheet material; manufacturing a plurality of steel sheet jaws by pressing the steel sheet material through a pressing process using a press; stacking the steel sheet jaws; and manufacturing a jaw having a predetermined thickness by spot-welding the steel sheet jaws.

### Advantageous Effects

As described above, according to the present invention, when the jaw holder is inserted into the pipe connecting member, the hooking protrusion of the jaw holder is inserted into the seating groove of the jaw holder while elastically contacting the inclined surface of the stopper of the pipe connecting member. Therefore, the jaw holder is easily securely coupled to the pipe connecting member.

Further, the jaws of the jaw holder can securely press and fix the pipe inserted into the jaw holder while pivoting.

In addition, by cutting opposite ends of the backup ring, spring supporting ring, sealing ring or varying a diameter of an inlet of the pipe connecting member, the backup ring, spring supporting ring, and seal ring can be easily inserted into the pipe connecting member.

### BRIEF DESCRIPTION OF DRAWINGS

FIG. 1 is an exploded perspective view of a pipe connecting apparatus according to a first embodiment of the present invention.

FIG. 2 is a perspective view of a jaw holder of FIG. 1, FIG. 3 is a longitudinal sectional view of the pipe connecting apparatus of FIG. 1, illustrating a state before a jaw holder is inserted into the pipe connecting member.

FIG. 4 is a longitudinal sectional view of the pipe connecting apparatus of FIG. 1, illustrating a state where a jaw holder is inserted into a pipe connecting member.

FIG. 5 is a perspective view of a jaw of FIG. 1.

FIG. 6 is a longitudinal sectional view illustrating a state just before a jaw of FIG. 1 is mounted in jaw mounting holes of a jaw holder.

FIG. 7 is a longitudinal sectional view illustrating a state where a jaw of FIG. 1 is mounted in jaw mounting holes of a jaw holder.

FIGS. 8 and 9 are perspective views of an elastic member of FIG. 1.

FIG. 10 is a flowchart illustrating a pipe connecting method according to a first embodiment of the present invention.

FIG. 11 is a perspective view of a pipe connecting apparatus according to a second embodiment, illustrating insertion of a backup ring into a pipe connecting member.

FIG. 12 is a perspective view of the pipe connecting apparatus, illustrating a state where a backup ring, spring supporting ring, and sealing ring are inserted into the pipe connecting member.

FIG. 13 is a longitudinal sectional view of the pipe connecting apparatus of FIG. 11.

FIG. 14 is a front view of the pipe connecting apparatus according to the second embodiment, illustrating an inlet of a pipe connecting member.

FIG. 15 is an exploded perspective view of a pipe connecting apparatus according to a third embodiment of the present invention.

FIG. 16 is a perspective view of a jaw holder of FIG. 15.

FIG. 17 is a longitudinal sectional view of the pipe connecting apparatus of FIG. 15, illustrating a state where jaws presses and fixes a pipe.

FIG. 18 is a longitudinal sectional view illustrating elastic deformation of an elastic hooking member when a jaw holder is inserted into a pipe connecting member.

FIG. 19 is a longitudinal sectional view illustrating a coupling state of a jaw holder of FIG. 15 to a pipe connecting member.

FIG. 20 is a flowchart illustrating a pipe connecting method according to a third embodiment of the present invention.

FIG. 21 is a perspective view of a preliminary assembling protrusion of the jaw holder.

FIG. 22 is a flowchart illustrating a method for manufacturing a jaw of a jaw holder according to an embodiment of the present invention.

### DESCRIPTION OF THE SYMBOLS IN MAIN PORTIONS OF THE DRAWINGS

100,200,300: Pipe connecting apparatus
110,310: Pipe connecting member
110a,310a: Inner wall
111: Inclined surface
120,320,420: Jaw holder
121,321,421: Jaw mounting hole
122: Hooking protrusion
123: Seating groove
124: Jaw hinge fixing protrusion
125: Jaw pivot stopper
130: Jaw
130a,330a: Teeth of jaw
134: First coupling groove
135: Second coupling groove
137: Inclined surface
140,340: Elastic member
250: Backup ring
260: Spring supporting ring
270: Sealing ring
311: Hooking protrusion
322: Inclined surface
324: Jaw hinge fixing protrusion
325: Jaw pivot stopper
326: Elastic hooking piece
334: First coupling groove
335: Second coupling groove
422: Preliminary assembling protrusion
D1: Diameter of inlet in horizontal direction of pipe connecting member
D2: Diameter of inlet in vertical direction of pipe connecting member

### BEST MODE FOR CARRYING OUT THE INVENTION

Reference will now be made in detail to an apparatus and method for interconnecting pipes and a method for manufacturing a jaw of a jaw holder in accordance with preferred embodiments of the present invention with reference to the accompanying drawings.

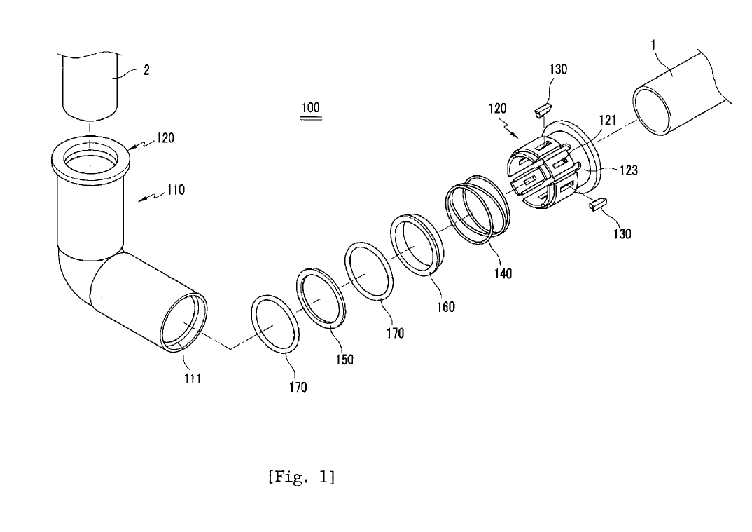

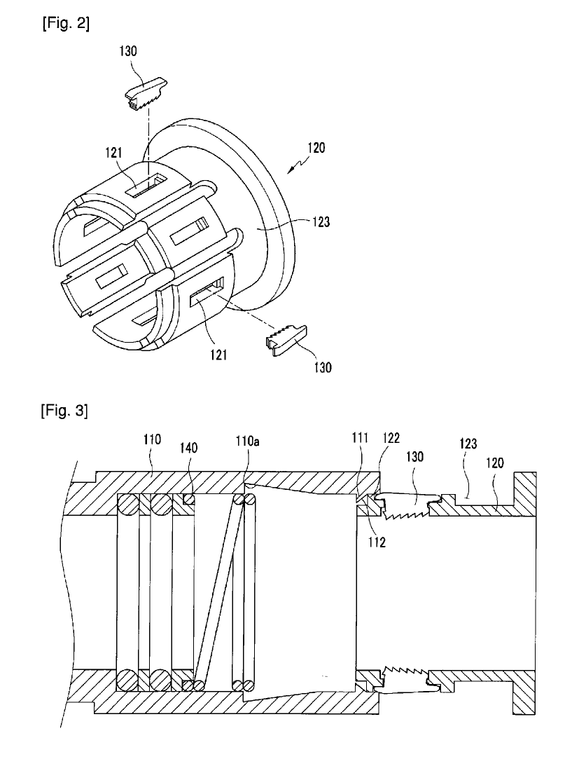

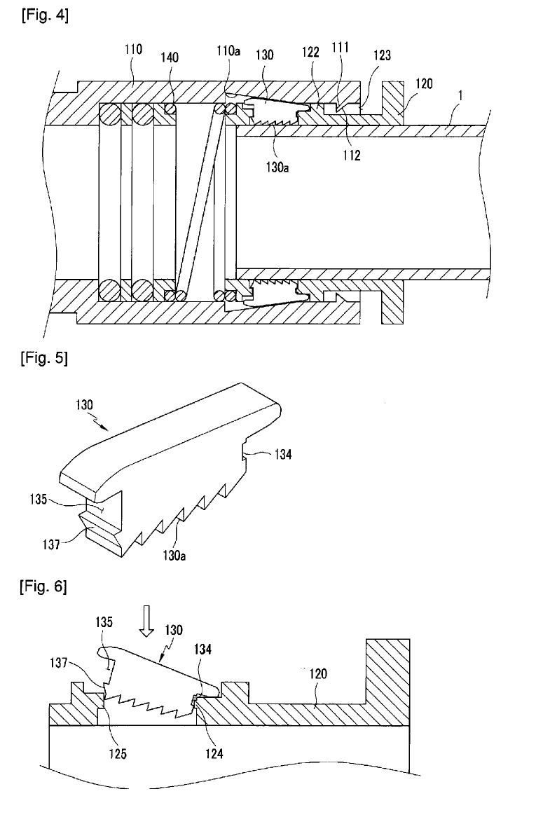

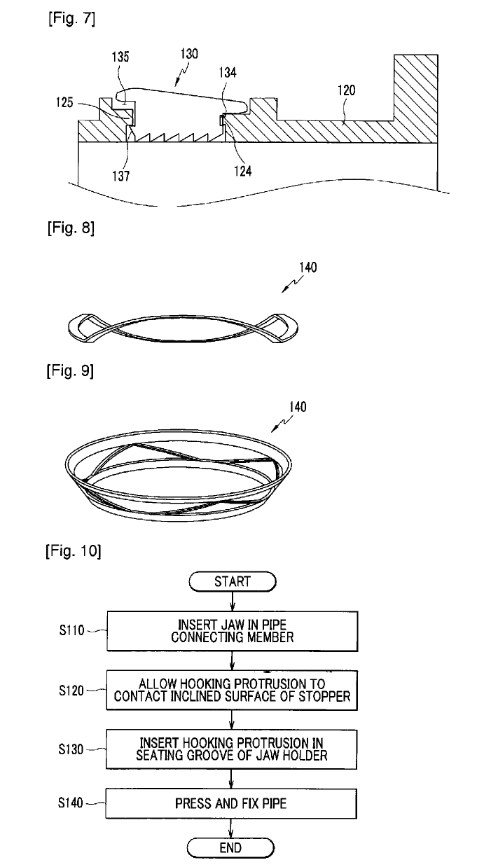

FIG. 1 is an exploded perspective view of a pipe connecting apparatus according to a first embodiment of the present invention, FIG. 2 is a perspective view of a jaw holder of FIG. 1, FIG. 3 is a longitudinal sectional view of the pipe connecting apparatus of FIG. 1, illustrating a state before a jaw holder is inserted into the pipe connecting member, FIG. 4 is a longitudinal sectional view of the pipe connecting apparatus of FIG. 1, illustrating a state where a jaw holder is inserted into a pipe connecting member, FIG. 5 is a perspective view of a jaw of FIG. 1, FIG. 6 is a longitudinal sectional view illustrating a state just before a jaw of FIG. 1 is mounted in jaw mounting holes of a jaw holder, and FIG. 7 is a longitudinal sectional view illustrating a state where a jaw of FIG. 1 is mounted in jaw mounting holes of a jaw holder.

Referring to FIGS. 1 through 7, a pipe connecting apparatus 100 according to a first embodiment of the present invention includes a pipe connecting member 110 installed at a location where two pipes 1 and 2 are interconnected; jaw holders 120 that are fixedly inserted into respective opposite end portions of the pipe connecting member 110 in a state where they are respectively interposed between the pipe connecting member 110 and the pipe 1 and between the pipe connecting member 110 and the pipe 2 and provided with a plurality of jaw mounting holes 121 that are formed along an outer circumference and spaced apart from each other at predetermined intervals; a plurality of jaws 130 that are pivotally inserted into the respective jaw mounting holes 121 and fix the pipes 1 and 2 inserted into the jaw holders 120 by being depressed by an inner wall 110a of the pipe connecting member 110; and elastic members 140 that are installed in the pipe connecting member 110 to elastically support the jaws 130.

Backup rings 150, spring supporting rings 160, and seal rings 170 are installed in the pipe connecting member 110.

The jaw holders 120 are respectively inserted into the opposite end portions of the pipe connecting member 110 to press and fix the pipes 1 and 2. The jaw holders 120 are identical in a function and a shape to each other. Therefore, for simplicity, only one jaw holder 120 that is associated with one end portion of the pipe connecting member 110 is illustrated in the drawings and the other is omitted.

Further, a seating groove 123 provided with a hooking protrusion 122 is formed along an outer circumference of the jaw holder 120 and a stopper 111 having an inclined surface 112 is formed on an inner circumference of the pipe connecting member 110 in response to the seating groove 123.

In this structure, when the jaw holder 120 is inserted into the pipe connecting member 110, the hooking protrusion 122 moves over the inclined surface 122 and thus the stopper 111 is inserted into the seating groove 123. As a result, the jaw holder 120 is coupled to the pipe connecting member 110.

The jaw holder 120 is preferably provided with a plurality of cut-away portions extending in a longitudinal direction thereof and spaced apart from the adjacent jaw mounting holes 121 at equal distances.

In the structure where the jaw holder 120 is provided with the cut-away portions spaced apart from the adjacent jaw mounting holes 121 at the equal distances, when the jaw holder 120 is inserted into the pipe connecting member 110, the jaw holder 120 can be resiliently inserted into the pipe connecting member 110.

The jaws 130 functions to press and fix the pipe 1, 2 inserted into the jaw holder by pivoting. A jaw hinge fixing protrusion 124 is formed on a first end wall defining each of the jaw mounting holes 121 and a jaw pivot stopper 125 is formed on a second end wall defining each of the jaw mounting holes 125.

A first coupling groove 134 corresponding to the jaw hinge fixing protrusion 124 is formed at a first end of the jaw 130 and a second coupling groove 135 corresponding to the jaw pivot stopper 125 is formed on a second end of the jaw 130.

The jaw 130 is capable of pivoting about the jaw hinge fixing protrusion 124 and a pivot range of the jaw 130 is restricted by the jaw pivot stopper 125.

An inclined surface 137 may be formed on the first end of the jaw 130. The jaw pivot stopper 125 is inserted and fixed in the second coupling groove 135 over the inclined surface 137.

The elastic member 14 may be variously modified. For example, the elastic member 14 may be a ring-shaped leaf spring having both sections one which is elevated above the other (see FIG. 8) or a ring-shaped leaf spring having upper and lower portions having different diameters (see FIG. 9).

The following will describe operation of the pipe connecting apparatus according to the first embodiment of the present invention.

In order to connect the two pipes 1 and 2 to each other, the jaw holders 120 are first pressed and inserted into the opposite inner end portions of the pipe connecting member 110, respectively.

Each of the jaw holders 120 is advanced to a certain extent such that the hooking protrusion 122 of the jaw holder 120 contacts the inclined surface 112 of the stopper 111 of the pipe connecting member 110 (see FIG. 3).

In this state, when the jaw holder 120 is further advanced, the hooking protrusion 122 is elastically deformed rearward to go over the inclined surface 112. As a result, the stopper 111 is inserted into the seating groove 123.

The jaw holder 120 maintains a coupling state to the pipe connecting member 110. In this state, when the pipe 1, 2 is inserted into the jaw holder 120, teeth 130a of the jaws 130 contact an outer circumference of the pipe 1, 2.

At this point, since the spring 140 resiliently supports the jaw 130, the jaws 130 are pressed toward the inner wall 110a of the pipe connecting member 110 and pivot about the respective jaw hinge fixing protrusions 124 to press and fix the pipe 1, 2 (see FIG. 4).

Describing in more detail a process for mounting the jaws on the jaw holder, when the jaw 130 is depressed in an arrow direction in a state where the jaw hinge fixing protrusion 124 is inserted into the first coupling groove 134 as shown in FIG. 6, the jaw pivot stopper 125 is inserted into the second coupling groove 135 by the inclined surfaces 137 and thus the jaw 130 is mounted on the jaw holder 120.

According to this structure, the jaw 130 can pivot about the jaw hinge fixing protrusion 124 and the pivot rage of the jaw 130 is restricted by the jaw pivot stopper 125.

FIG. 10 is a flowchart illustrating a pipe connecting method according to a first embodiment of the present invention.

Referring to FIG. 10, a pipe connecting method according to a first embodiment of the present invention includes inserting the jaw holders into the respective opposite end portions of the pipe connecting member (S110); allowing the hooking protrusions of the jaw holders to contact the inclined surfaces of the stoppers of the pipe connecting member (S120); inserting the stoppers into the seating grooves by depressing the jaw holders and thus elastically deforming the hooking protrusions of the jaw holders (S130); and allowing the jaws to press and fix the pipes inserted into the jaw holders by allowing the springs mounted in the pipe connecting member to resiliently support the jaws of the jaw holders (S140).

Meanwhile, as previously described, the backup rings, spring supporting rings, seal rings, and the like are installed in the pipe connecting member to support the springs or realize a seal.

The pipe connecting member may be shaped through a hydroforming process or other processes in accordance with design conditions such that diameters of inlets thereof are smaller than a diameter of the main body. For the pipe connecting member shaped as described above, it is difficult to insert the backup rings, spring supporting rings, seal rings, and the like into the pipe connecting member. The following will describe two structures that enable the backup rings, spring supporting rings, seal rings, and the like to be more easily inserted into the pipe connecting member.

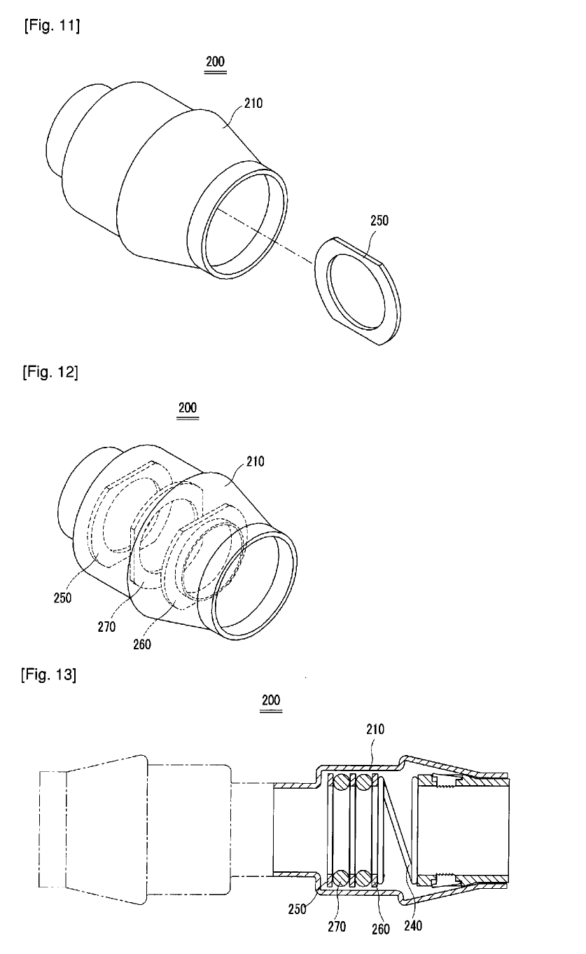

FIG. 11 is a perspective view of a pipe connecting apparatus according to a second embodiment, illustrating insertion of a backup ring into a pipe connecting member, FIG. 12 is a perspective view of the pipe connecting apparatus, illustrating a state where a backup ring, spring supporting ring, and sealing ring are inserted into the pipe connecting member, and FIG. 13 is a longitudinal sectional view of the pipe connecting apparatus of FIG. 11.

As shown in FIGS. 11 through 13, in a pipe connecting apparatus 20 according to a second embodiment, inlets of the pipe connecting member 210 remains as they were and opposite ends of each of a backup ring 250, spring supporting ring 260, and sealing ring 270 are cut away so that they can be inserted into the pipe connecting member 210.

According to this structure, the backup ring 250, spring supporting ring 260, and seal ring 270 can be easily inserted into the pipe connecting member 210 in a state where they are positioned obliquely.

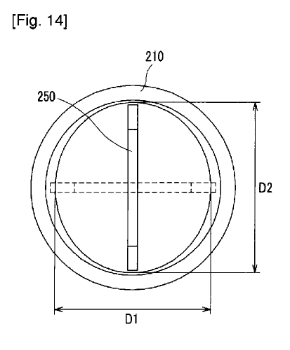

FIG. 14 is a front view of the pipe connecting apparatus according to the second embodiment, illustrating an inlet of a pipe connecting member.

As shown in FIG. 14, in the pipe connecting apparatus 200 according to the second embodiment, a variety of rings, for example, such as the backup ring 250 remains at it was but an inlet of the pipe connecting member 210 is modified.

That is, the inlet of the pipe connecting member 210 is designed such that a diameter D1 thereof in a horizontal direction is less than a diameter D2 thereof in a vertical direction so that the backup ring 250 can be inserted into the pipe connecting member 210. In this structure, the backup ring 250 is oriented in the vertical direction and, in this state, it is easily inserted through the diameter D1 of the pipe connecting member 210.

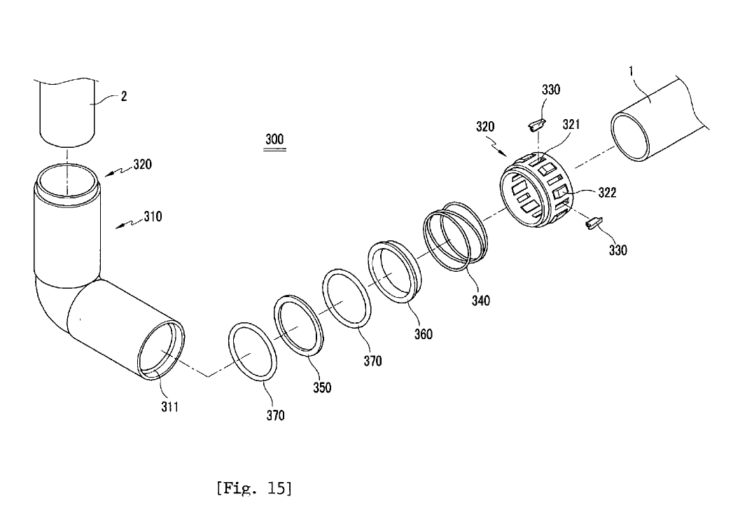

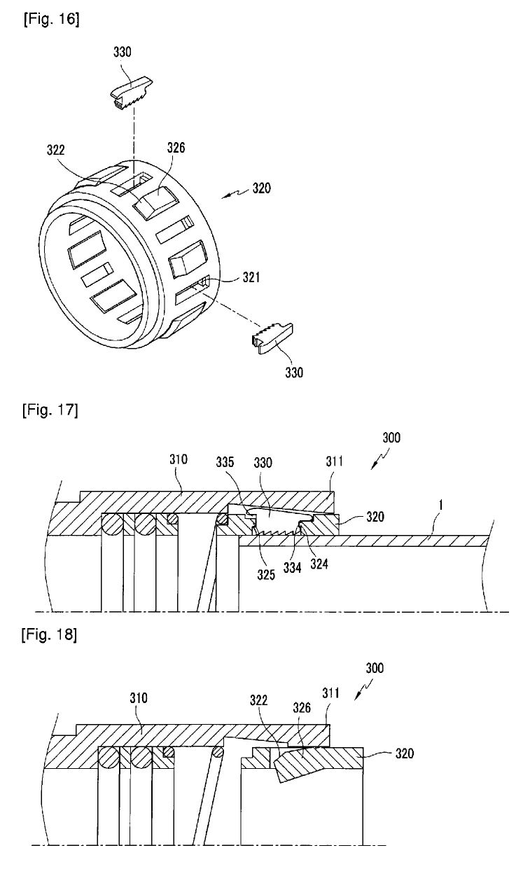

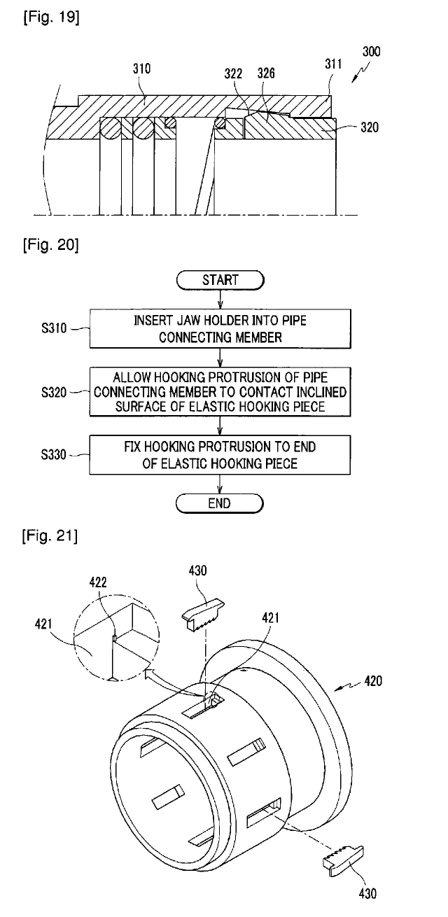

Meanwhile, FIG. 15 is an exploded perspective view of a pipe connecting apparatus according to a third embodiment of the present invention, FIG. 16 is a perspective view of a jaw holder of FIG. 15, FIG. 17 is a longitudinal sectional view of the pipe connecting apparatus of FIG. 15, illustrating a state where jaws presses and fixes a pipe, FIG. 18 is a longitudinal sectional view illustrating elastic deformation of an elastic hooking member when a jaw holder is inserted into a pipe connecting member, and FIG. 19 is a longitudinal sectional view illustrating a coupling state of a jaw holder of FIG. 15 to a pipe connecting member.

Referring to FIGS. 15 through 19, a pipe connecting apparatus according to a third embodiment of the present invention includes a pipe connecting member 310 disposed between two pipes 1 and 2 and interconnecting the two pipes 1 and 2; jaw holders 320 that are fixedly inserted into respective opposite end portions of the pipe connecting member 310 in a state where they are respectively interposed between the pipe connecting member 310 and the pipe 1 and between the pipe connecting member 310 and the pipe 2 and provided with a plurality of jaw mounting holes 321 that are formed along an outer circumference and spaced apart from each other at predetermined intervals; a plurality of jaws 330 that are pivotally inserted into the respective jaw mounting holes 321 and fix the pipes 1 and 2 inserted into the jaw holders 320 by being depressed by an inner wall 310a of the pipe connecting member 310; and elastic members 340 that are installed in the pipe connecting member 310 to elastically support the jaws 330.

Backup rings 350, spring supporting rings 360, and seal rings 370 are installed in the pipe connecting member 310.

The jaws 330 functions to press and fix the pipe 1, 2 inserted into the jaw holder by pivoting. A jaw hinge fixing protrusion 324 is formed on a first end wall defining each of the jaw mounting holes 321 and a jaw pivot stopper 125 is formed on a second end wall defining each of the jaw mounting holes 325.

A first coupling groove 334 corresponding to the jaw hinge fixing protrusion 324 is formed at a first end of the jaw 330 and a second coupling groove 335 corresponding to the jaw pivot stopper 325 is formed on a second end of the jaw 330. Therefore, the jaw 330 is capable of pivoting about the jaw hinge fixing protrusion 324 and a pivot range of the jaw 330 is restricted by the jaw pivot stopper 125.

The jaw holder 320 is provided at an outer circumference thereof with a plurality of elastic hooking pieces 326 spaced apart from each other at predetermined intervals and each having an inclined surface 322. The pipe connecting member 310 is provided at an inner circumference thereof with a hooking protrusion 311 corresponding to the elastic hooking pieces 326.

According to the above-described structure, when the jaw holder 320 is inserted into the pipe connecting member 310, the hooking protrusion 311 moves over the inclined surfaces 322 and thus resiliently hooked on ends of the elastic hooking pieces 326. As a result, the jaw holder 320 is coupled to an end portion of the pipe connecting member 310.

Although not shown in the drawings, the circumference of the jaw holder 320 may be provided with longitudinal cut away portions. In this case, the jaw holder 320 may be resiliently inserted and coupled into the pipe connecting member 310.

The following will describe operation of the pipe connecting apparatus according to the third embodiment of the present invention.

In order to connect the two pipes 1 and 2 to each other, the jaw holders 320 are first pressed and inserted into the opposite inner end portions of the pipe connecting member 310, respectively.

Each of the jaw holders 320 is advanced to a certain extent such that the hooking protrusion 322 of the jaw holder 320 go over the inclined surfaces 322 of the elastic hooking pieces 326 and thus the hooking protrusion 322 is hooked on the ends of the elastic hooking pieces 326. As a result, the jaw holder 320 is coupled to the end portion of the pipe connecting member 310. 3).

In this state, when the pipe 1, 2 is inserted into the jaw holder 120, teeth 330a of the jaws 330 contact an outer circumference of the pipe 1, 2.

At this point, since the spring 340 resiliently supports the jaw 330, the jaws 330 are pressed toward the inner wall 310a of the pipe connecting member 310 and pivot about the respective jaw hinge fixing protrusions 324 to press and fix the pipe 1, 2 (see FIG. 4).

FIG. 20 is a flowchart illustrating a pipe connecting method according to a third embodiment of the present invention.

Referring to FIG. 20, a pipe connecting method according to a third embodiment of the present invention includes inserting the jaw holders into the respective opposite end portions of the pipe connecting member (S310); allowing the elastic hooking pieces of the jaw holders to contact the hooking protrusions of the pipe connecting member (S320); and coupling the jaw holders to the pipe connecting member by allowing the hook protrusion of the pipe connecting member to be hooked on the ends of the elastic holing pieces of the jaw holders by elastically deforming the elastic hooking pieces of the jaw holders by pressing the jaw holders (330).

FIG. 21 is a perspective view of a preliminary assembling protrusion of the jaw holder.

Referring to FIG. 21, a structure where the jaw 430 is simply inserted in the jaw mounting hole 421 of the jaw holder 420 is also possible. A preliminary assembling protrusion 422 is formed on an inner circumference of the jaw mounting hole 421. When the jaw 430 is inserted into the jaw mounting hole 421, the jaw 430 is not removed from the jaw mounting hole 421 by the preliminary protrusion 422. In this case, the working efficiency can increase when the jaw holder 420 is coupled to the pipe connecting member 410.

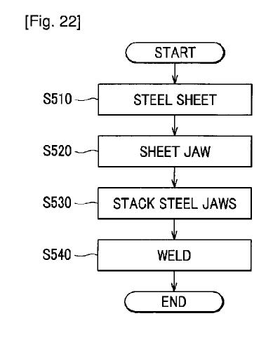

FIG. 22 is a flowchart illustrating a method for manufacturing a jaw of a jaw holder according to an embodiment of the present invention.

Referring to FIG. 22, a method for manufacturing a jaw of a jaw holder according to the present invention includes preparing a steel sheet material (S510), manufacturing a plurality of steel sheet jaws by pressing the steel sheet material through a pressing process using a press (S520), stacking the steel sheet jaws (S530), and manufacturing a jaw having a predetermined thickness by spot-welding the steel sheet jaws (S540).

In the prior art, the jaw having a thickness of, for example, 1.6 mm has been formed through a casting process. In this case, working efficiency is deteriorated and thus manufacturing cost increases.

According to the present invention, the steel jaws each having a thickness of, example, 0.8 mm are formed through the pressing process and the jaw having a thickness of 1.6 mm are manufacturing by spot-welding the steel sheet jaws. Therefore, the working efficiency is improved and thus the manufacturing cost can be significantly reduced.

Although the present invention is applied to an elbow type in the above exemplary embodiments of the present invention, the present invention can be also applied to a T-shape type, a cross-shape type, and the like.

It will be apparent to those skilled in the art that various modifications and variations can be made in the present invention. Thus, it is intended that the present invention covers the modifications and variations of this invention provided they come within the scope of the appended claims and their equivalents.

1. A pipe connecting apparatus comprising:
a pipe connecting member installed at a location where two pipes are interconnected;
one or more jaw holder that are fixedly inserted into respective opposite end portions of the pipe connecting member in a state where they are respectively interposed between the pipe connecting member and the pipe and between the pipe connecting member and the pipe and provided with a plurality of jaw mounting holes that are formed along an outer circumference and spaced apart from each other at predetermined intervals;
one or more jaws that are pivotally inserted into the respective jaw mounting holes and press and fix the pipes inserted into the jaw holders by being depressed by an inner wall of the pipe connecting member; and
one or more elastic members that are installed in the pipe connecting member to elastically support the jaws,
wherein a seating groove provided with a hooking protrusion is formed along an outer circumference of the jaw holder and a stopper having an inclined surface is formed on an inner circumference of the pipe connecting member in response to the seating groove; and
when the jaw holder is inserted into the pipe connecting member, the hooking protrusion moves over the inclined surface, the stopper is inserted into the seating groove, and thus the jaw holder is coupled to the pipe connecting member.

2. The pipe connecting apparatus of claim 1, wherein The jaw holder is provided with a plurality of cut-away portions extending in a longitudinal direction thereof and spaced apart from the adjacent jaw mounting holes 121 at equal distances.

3. The pipe connecting apparatus of claim 1, wherein a jaw hinge fixing protrusion is formed on a first end wall defining each of the jaw mounting holes and a jaw pivot stopper is formed on a second end wall defining each of the jaw mounting holes;
a first coupling groove corresponding to the jaw hinge fixing protrusion is formed at a first end of the jaw and a second coupling groove corresponding to the jaw pivot stopper is formed on a second end of the jaw; and
the jaw is designed to pivot about the jaw hinge fixing protrusion and a pivot range of the jaw is restricted by the jaw pivot stopper.

4. The pipe connecting apparatus of claim 1, an inclined surface is formed on the first end of the jaw so that the jaw pivot stopper is inserted and fixed in the second coupling groove over the inclined surface.

5. The pipe connecting apparatus of claim 1, wherein a backup ring, spring supporting ring, and sealing ring are inserted into the pipe connecting member; and
opposite side ends of each of the backup ring, spring supporting ring, and sealing ring are cut away so that they can be inserted into the pipe connecting member.

6. The pipe connecting apparatus of claim 1, wherein a backup ring, spring supporting ring, and sealing ring are inserted into the pipe connecting member; and
an inlet of the pipe connecting member is designed such that a diameter thereof in a horizontal direction is less than a diameter thereof in a vertical direction so that the backup ring, spring supporting ring, and sealing ring can be inserted into the pipe connecting member.

7. The pipe connecting apparatus of claim 1, wherein the elastic member is a ring-shaped leaf spring having both sections one which is elevated above the other.

8. The pipe connecting apparatus of claim 1, wherein the elastic member is a ring-shaped leaf spring having upper and lower portions having different diameters.

9. A pipe connecting apparatus comprising:
a pipe connecting member disposed between two pipes and interconnecting the two pipes;
one or more jaw holders that are fixedly inserted into respective opposite end portions of the pipe connecting member in a state where they are respectively interposed between the pipe connecting member and the pipe and between the pipe connecting member and the pipe and provided with a plurality of jaw mounting holes that are formed along an outer circumference and spaced apart from each other at predetermined intervals;
one or more jaws that are pivotally inserted into the respective jaw mounting holes and press and fix the pipes inserted into the jaw holders by being depressed by an inner wall of the pipe connecting member; and
one or more elastic members that are installed in the pipe connecting member to elastically support the jaws,
wherein the jaw holder is provided at an outer circumference thereof with a plurality of elastic hooking pieces spaced apart from each other at predetermined intervals and each having an inclined surface and the pipe connecting member is provided at an inner circumference thereof with a hooking protrusion corresponding to the elastic hooking pieces; and
when the jaw holder is inserted into the pipe connecting member, the hooking protrusion 311 moves over the inclined surfaces and thus resiliently hooked on ends of the elastic hooking pieces, and the jaw holder is coupled to an end portion of the pipe connecting member.

10. The pipe connecting apparatus of claim 9, wherein the elastic hooking pieces are formed by cutting an outer circumference of the jaw holder.

11. The pipe connecting apparatus of claim 9, wherein a preliminary assembling protrusion is formed on an inner circumference of the jaw mounting hole to fix a position of the jaw.

12. The pipe connecting apparatus of claim 9, wherein a backup ring, spring supporting ring, and sealing ring are inserted into the pipe connecting member; and
opposite side ends of each of the backup ring, spring supporting ring, and sealing ring are cut away so that they can be inserted into the pipe connecting member.

13. The pipe connecting apparatus of claim 9, wherein a backup ring, spring supporting ring, and sealing ring are inserted into the pipe connecting member; and
an inlet of the pipe connecting member is designed such that a diameter thereof in a horizontal direction is less than a diameter thereof in a vertical direction so that the backup ring, spring supporting ring, and sealing ring can be inserted into the pipe connecting member.

14. (canceled)

15. A pipe connecting method comprising:
inserting jaw holders into respective opposite end portions of a pipe connecting member;
allowing hooking protrusions of the jaw holders to contact inclined surfaces of stoppers of the pipe connecting member;
inserting the stoppers into seating grooves by depressing the jaw holders and thus elastically deforming the hooking protrusions of the jaw holders; and
allowing the jaws to press and fix pipes inserted into the jaw holders by allowing springs mounted in the pipe connecting member to resiliently support the jaws of the jaw holders.

16. A pipe connecting method comprising:
inserting jaw holders into respective opposite end portions of a pipe connecting member;
allowing elastic hooking pieces of the jaw holders to contact hooking protrusions of the pipe connecting member; and
coupling the jaw holders to the pipe connecting member by allowing the hook protrusion of the pipe connecting member to be hooked on the ends of the elastic holing pieces of the jaw holders by elastically deforming the elastic hooking pieces of the jaw holders by pressing the jaw holders.
